(19) United States
(12) Patent Application Publication
(10) Pub. No.: US 2020/0312578 A1
(43) Pub. Date: Oct. 1, 2020

(54) POROUS CARBON MATERIAL DERIVED FROM A NATURAL OR SYNTHETIC PRECURSOR

(71) Applicant: Sparkle Power LLC, Rochester, NY (US)

(72) Inventor: David Mitlin, Lakeway, TX (US)

(21) Appl. No.: 16/829,192

(22) Filed: Mar. 25, 2020

Related U.S. Application Data
(60) Provisional application No. 62/823,212, filed on Mar. 25, 2019.

(51) Int. Cl. H01G 11/32; C01B 32/318

(52) U.S. Cl. CPC H01G 11/32; C01B 32/318; C01P 2004/61; C01P 2006/10; C01P 2006/17; C01P 2006/40; C01P 2006/12

(57) ABSTRACT

A novel carbon material for use in electrochemical energy storage devices. A carbon material derived from a natural precursor or synthetic precursor, the carbon material including: a mean particle size between 1-40 microns; a BET surface area between 750-3500 m²/g; and a pore size distribution being a combination of microporosity, mesoporosity and/or macroporosity.

### CROSS-REFERENCE TO RELATED APPLICATIONS

The instant application claims priority to co-pending U.S. Provisional Application No. 62/823,212, filed on Mar. 25, 2019, and entitled “Porous Carbons with Ultra Low Self Discharge and Ultra High Density Derived from Hemp and Cannabis for Energy Storage”. The entirety of the aforementioned provisional application is incorporated by reference in its entirety.

### FIELD OF THE INVENTION

The present disclosure relates to a novel carbon material, and in particular, the present disclosure relates to a novel carbon material for use as an electrode in an energy storage device.

### BACKGROUND OF THE INVENTION

Energy-storage devices, such as, ultracapacitors (and, e.g., batteries, supercapacitors, electrochemical capacitors), have conventionally been designed for high rate-high cyclability energy storage, albeit at roughly a hundred times lower gravimetric and volumetric energy, as compared to, e.g., lithium ion batteries. Some of the end-uses for ultracapacitors, for instance, include solar and wind capacity firming, grid power regulation and leveling, voltage control, windmill pitch control, heavy truck/bus transport start-stop assist, and peak power assist, industrial shut-down support, among others. One way to classify supercapacitor devices is by their primary charge storage mechanism. As one skilled in the art will understand, most commercial ultracapacitor devices are exclusively electrical double layer capacitance (EDLC) devices which, for instance, store energy through reversible accumulation of charged ions in a double layer at an electrode's surface. While research is ongoing in alternative electrolytes, such as, ionic liquids (ILs), most commercial devices operate using a salt dissolved in an organic electrolyte that is designed to minimize parasitic side reactions at high voltages, for instance considering the Maxwell K2 Cell offering. It is recognized however that an aqueous electrolyte has substantial advantages in terms of safety, environmental friendliness and potential cost reduction. Similar to aqueous batteries, aqueous supercapacitors can be impactful in the energy storage field where the intrinsic low cost and safety of water-based systems are important.

Pseudocapacitors are another class of ultracapacitor-like energy storage devices, with energy storage capability primarily originating from reversible faradaic reactions that occur at, and near the active material's (e.g., electrode's) surface. A hybrid configuration (e.g., oxide on the positive electrode, carbon on the negative electrode), does somewhat extend the device voltage window by kinetically suppressing the decomposition of water above 1.2 V. The extent of the parallel EDLC contribution to energy storage in pseudocapacitor devices will depend on the surface area of the active (i.e., electrode) materials. Even the best performing nanostructured oxides, will typically possess surface areas that are at, or below 300 m²g⁻¹, which typically gives a relatively modest EDLC response. Oxide-based faradaic systems have seen less commercial activity, presumably due to a combination of increased electrode cost and the inherent propensity of most oxides to coarsen over time, due to voltage-induced dissolution or dissolution-reprecipitation. Unfortunately, oxides and oxynitrides are not fully stable during extended charging-discharging, leading to lifetimes of 10,000 cycles or less for even the state-of-the-art systems.

There remains a need for enhanced energy-storage devices, and in particular, a need for a novel, carbon material for enhanced performance efficiency of such devices.

### SUMMARY

One aspect of the invention is directed to a carbon material derived from a natural precursor or synthetic precursor, the carbon material comprising: a mean particle size between 1-40 microns; a BET surface area between 750-3500 m²/g; and a pore size distribution being at least one of microporosity, mesoporosity and macroporosity.

In one embodiment, the carbon material comprises a maximum content of 0 is less than 7 wt. %. In another embodiment, the maximum content of 0 is less than 4 wt. %. In another embodiment, the maximum content of 0 is less than 2 wt. %.

In one embodiment of the carbon material, the natural precursor is one of a fibrous plant material, wood, a forestry product, a petroleum product, coal, or an agricultural product. In one embodiment, the fibrous plant material is one of hemp or cannabis. In one embodiment, the synthetic precursor is an industrial plastic.

In one embodiment of the carbon material, the mean particle size is between 2-20 microns; the BET surface area between 1000-3500 m²/g; and/or the pore size distribution comprising 50% of pore volume has a width of between 2-4 nm and 50% of pore volume has a width of between 1-2 nm.

Another embodiment of the invention is directed to an energy storage device comprising: an anode; and a cathode, wherein at least one of said anode and cathode includes a carbon material according to any of the above embodiments. In one embodiment, the energy storage device has a volumetric capacitance of 45 F/cc.

In one embodiment, the energy storage device is a symmetric electrochemical capacitor. In one embodiment, the energy storage device further comprises an organic electrolyte. In one embodiment, the organic electrolyte comprises 1.0 M tetraethylammonium tetrafluoroborate (TEATFB) salt in acetonitrile solvent.

In one embodiment of energy storage device the anode is a zinc-based anode; and the cathode is an oxide-based cathode, the carbon material is combined with the zinc based anode and the oxide-based cathode.

Another embodiment is directed to an electrode for an energy storage device comprising a carbon material as described above. In one embodiment, the electrode has a density of 0.94 g/cm³.

Another embodiment is directed to a method of making an electrode described above, the method comprising: providing a carbon material according to any of the above embodiments; drying the carbon material at 65° C. for one hour; and mixing the dried carbon material with a polytetrafluoroethylene (PTFE, commercially available as TEFLON™) binder at 3.0 wt. % until thoroughly blended. In one embodiment, the method further comprises forming a sheet from the blended mixture of dried carbon material.

These and other embodiments are described in more detail below and illustrated in the attached drawings.

### BRIEF DESCRIPTION OF THE DRAWINGS

FIG. 1(a) is a schematic of a carbon material according to embodiments herein.

FIG. 1(b) is a schematic of an electrochemical energy device in accordance with an embodiment described herein.

FIG. 2 is a graph of 30-minute leakage current values at different voltages for symmetric test cells according to embodiments discussed herein.

FIG. 3 is a graph of discharge behavior of symmetric capacitor cells according to embodiments discussed herein.

FIG. 4 is a graph of discharge behavior of symmetric capacitor cells according to embodiments discussed herein.

FIG. 5 is a graph of discharge behavior of symmetric capacitor cells according to embodiments discussed herein.

FIGS. 6(a) and 6(b) and 6(c) are graphs of impedance data.

FIG. 7 is a graph of discharge capacitance values.

FIGS. 8(a) and 8(b) are Ragone plots for test cells according to embodiments herein.

FIG. 9 is a graph illustrating leakage current.

FIG. 10 is a graph illustrating open-circuit voltage decay.

FIG. 11 is a graph illustrating discharge times and percent change in discharge time as a function of cycle number for 10 mA constant-current charge/discharge cycling.

FIG. 12 is a graph illustrating discharge times and percent change in discharge time as a function of cycle number for 10 mA constant-current charge/discharge cycling.

### DETAILED DESCRIPTION OF THE INVENTION

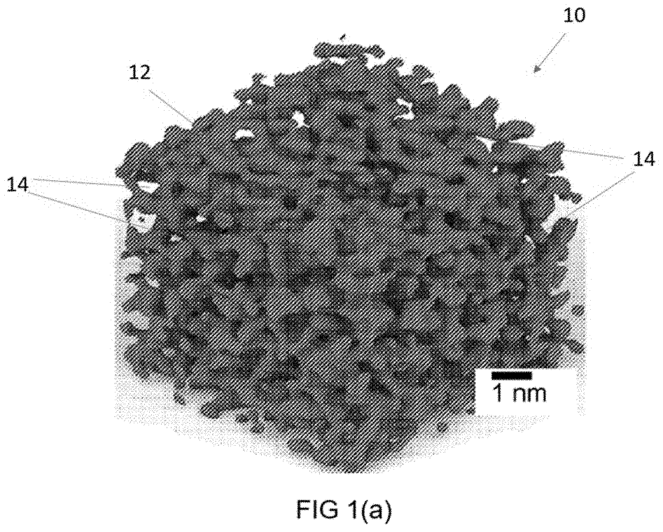

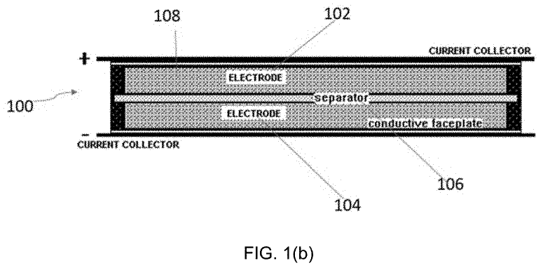

This invention concerns, as shown in FIG. 1(a), a carbon material 10 that possesses unique physical, chemical and textural (density, porosity, pore size distribution) properties. These characteristics of the carbon material 10 lead to exceptional electrochemical energy storage performance. The obtained carbon materials 10 are derived from natural or synthetic precursors. Examples of natural precursors include hemp, cannabis and other fibrous plant materials, wood, forestry and agricultural products and byproducts. The carbon materials 10 may alternatively be derived from petroleum products, coal, and industrial plastics.

One aspect of the invention is directed to a carbon material 10 that is derived from a natural precursor or synthetic precursor. Examples of natural precursors include hemp, cannabis and other fibrous plant materials, wood, forestry and agricultural products and byproducts, and combinations thereof. Other examples of natural precursors include petroleum products and coal. Examples of synthetic precursors are industrial plastics, byproducts thereof, and combinations thereof.

In one particular embodiment, the precursor is hemp and/or cannabis. In a specific embodiment, the precursor is cannabis. In another specific embodiment, the precursor is hemp, including fiber, bast, hurd, any waste from the hemp itself.

The synthesis process of the carbon material 10 includes physical and or chemical activation, including one or a combination of phosphoric acid, steam, nitrogen, potassium hydroxide, sodium hydroxide, carbon dioxide, hydrogen and other reactive gases. It is envisioned that the synthesis process also may include a washing treatment before and or after the activation process. The synthesis process includes temperatures of between about 400° C. to about 1200° C., and occurs over a period of 1 min to about 24 hours. The invention is not limited in this regard as the temperature can be any temperature or range of temperature, e.g., 500° C. to about 1100° C.; 600° C. to about 1000° C.; 700° C. to about 900° C., etc. Additionally, the invention is not limited in this regard as the time period can be any time period or range of time, e.g., 30 mins to 24 hours; 2 hours to 22 hours; 3 hours to 20 hours; 5 hours to 15 hours; 10 hours to 12 hours, etc.

In one embodiment, the carbon material 10 includes a plurality of particles 12. In one embodiment, the carbon material 10 includes a mean particle size between 1-40 microns. In another embodiment, the carbon material 10 includes a mean particle size between 2-20 microns.

In one embodiment, the carbon material 10 includes a BET surface area between 750-3500 m²/g. In another embodiment, the carbon material includes a BET surface area between 1000-3500 m²/g.

The carbon material 10 according to the present invention has a plurality of pores 14, i.e., it has porosity. In one embodiment, the carbon material 10 has a pore size distribution being a combination of microporosity, mesoporosity and/or macroporosity. Microporosity or “microporous” relate to pores with diameters (i.e., width) less than 2 nm. Mesoporosity or “mesoporous” relate to pores with diameters between 2 and 50 nm. Macroporosity or “macroporous” relate to pores with diameters larger than 50 nm.

In one embodiment, the carbon material 10 has 100% volume of microporous pores, i.e., all of the pores are microporous. In another embodiment, the carbon material has 100% volume of mesoporous pores, i.e., all of the pores are mesoporous. In another embodiment, the carbon material 10 has 100% volume of macroporous pores, i.e., all of the pores are macroporous. Other embodiments of the carbon material 10 may include a combination of two or more of the foregoing: microporous pores, mesoporous pores, and macroporous pores. For example, in one embodiment, 50% of the pore volume is microporous and 50% of the pore volume is mesoporous. In a specific example, 50% of the pore volume has a width (diameter) of between 2-4 nm and 50% of pore volume has a width (diameter) of between 1-2 nm. The carbon material 10 is not limited in this regard as any volume of pores can be micropores, mesopores, and/or macropores, e.g., 100% micropores, 100% mesopores, 100% macropores, any combination of micropores/mesopores, any combination of micropores/macropores, any combination of mesopores/macropores, or any combination of micropores/mesopores/macropores.

In one embodiment, the carbon material 10 has a maximum content of 0 is less than 7 wt. % based on the total weight of the carbon material. In another embodiment, the maximum content of O is less than 4 wt. % based on the total weight of the carbon material. In another embodiment, the maximum content of O is less than 2 wt. % based on the total weight of the carbon material.

In a particular embodiment, the carbon material 10 has a mean particle size between 1-40 microns, a BET surface area between 750-3500 m²/g, a pore size distribution being a combination of microporosity, mesoporosity and/or macroporosity, and a density of 0.94 g/cm³ or higher.

In another particular embodiment of the carbon material 10, the mean particle size is between 2-20 microns; the BET surface area between 1000-3500 m²/g; and the pore size distribution comprising 50% of pore volume has a width of between 2-4 nm and 50% of pore volume has a width of between 1-2 nm.

The carbon material 10 comprises trace amounts of metal content and inorganic content, i.e., metal content and inorganic content in the carbon material is in ppm ranges.

Another embodiment of the invention is directed to an electrochemical energy storage device 100 as shown in FIG. 1(b). Examples of electrochemical energy storage devices 100 include, but are not limited to, batteries, capacitors, supercapacitors, ultracapacitors, symmetric capacitors, hybrid capacitors, and the like. Energy storage device 100 includes at least one electrode. In the embodiment shown in FIG. 1(b), the device 100 includes a cathode 102, an anode 104, a separator 106, and an electrolyte 108. Separator 106 and electrolyte 108 are known in the art and acceptable to use in the device 100. In one embodiment, the electrolyte 108 is an organic electrolyte or an aqueous electrolyte. In one embodiment, the electrolyte 108 is an organic electrolyte that includes 1.0 M tetraethylammonium tetrafluoroborate (TEATFB) salt in acetonitrile (ACN) solvent.

In one embodiment, the energy storage device 100 has a volumetric capacitance of 45 F/cc.

In a particular embodiment, the energy storage device 100 is a symmetric electrochemical capacitor, wherein the electrolyte 108 is an organic electrolyte that includes 1.0 M tetraethylammonium tetrafluoroborate (TEATFB) salt in acetonitrile solvent.

In a particular embodiment of the device 100, the carbon material 10 is combined with an oxide-based cathode such as sodium vanadium phosphate or Prussian Blue. In one embodiment, the carbon material 10 is combined with a zinc-based anode. It is envisioned that the aforementioned anode and cathode can be used separately in different devices or as a combination. The aforementioned anode and cathode, when combined, fabricates a hybrid sodium ion or potassium ion battery. The battery can operate with an organic or aqueous based electrolyte 108.

Another embodiment of the invention is directed to an electrode 102, 104 for an energy storage device 100. The electrode 102, 104 includes a carbon material as described above. In one embodiment, the electrode 102, 104 has a density of 0.94 g/cm³. In one embodiment, the electrode is a zinc-based anode. In one embodiment, the electrode is an oxide-based cathode, such as sodium vanadium phosphate or Prussian Blue.

Another embodiment is directed to a method of making an electrode 102, 104, as described above. The method includes providing a carbon material 10 according to any of the above embodiments and drying the carbon material at 65° C. for an amount of time. In one embodiment, the carbon material 10 is dried for one hour. The dried carbon material is mixed with a polytetrafluoroethylene (PTFE, commercially available as TEFLON™) binder at 3.0 wt. % until thoroughly blended. In one embodiment, the method further comprises forming a sheet from the blended mixture of dried carbon material.

### EXAMPLES

I. Materials and Preparation

Carbon material in accordance with embodiments herein was fabricated and tested. In particular, carbon material derived from a natural precursor, and specifically derived from hemp fiber, was made and tested. (Referred herein after as “SPC” and, in particular embodiments, are referred to as SPC 1A, SPC 1B, SPC 2A, SPC 2B, which denote a first batch made into two samples (SPC 1A and SPC 1B, also labeled with January 2019 #1 and January 2019 #2, respectively) and a second batch made into two samples (SPC 2A and SPC 2B, also labeled as March 2019 #1 and March 2019 #2, respectively.)

The synthesis process consisted of physical and or chemical activation, including one or a combination of phosphoric acid, steam, nitrogen, potassium hydroxide, sodium hydroxide, carbon dioxide, hydrogen and other reactive gases. It is envisioned that the synthesis process also may include a washing treatment before and or after the activation process.

To make the electrode, SPC was dried at 65° C. for 1 hour and then mixed at high-shear with a polytetrafluoroethylene (PTFE, commercially available as Teflon™) binder at 3.0% by weight. This mixture was thoroughly blended and formed into sheets. The resultant electrode sheet was shiny, which is an indication of a high graphitic content. Sheets were 0.002″ thick and punched using a steel die to make discs 0.625″ in diameter for testing as electrodes in symmetric electrochemical capacitor cells.

The SPC material was evaluated for its properties and performance as electrodes in symmetric electrochemical capacitors with an organic electrolyte comprised of 1.0 M TEATFB salt in acetonitrile solvent. A comprehensive set of property and performance measurements was performed on this sample. Results are compared to those for the Kuraray YP-50 carbon control sample tested and reported in January 2019 (“YP-50”). Kuraray YP-50 is a state-of-the-art dense supercapacitor carbon widely used in industry.

A group of the electrode discs was weighed together to an accuracy of 0.1 mg. The average mass and density of a pair of electrodes is shown in Table I along with the mass and density of SPC 1A and 1B, SPC 2A and 2B, and YP-50 electrodes (electrodes made with commercially available activated carbon). The electrode density for the SPC 2A and SPC 2B samples is significantly greater than the 0.6-0.65 g/cm³ value typically observed for electrodes made using commercial activated carbon (YP-50). It is believed the high density of the SPC samples are indicative of a different carbon structure than that of the YP-50 rather than incomplete activation.

As the last preparation step, the electrodes were dried under vacuum conditions (mechanical roughing pump) in a special container at 195° C. for 15 hours.

TABLE I
Electrode masses and volumes for each electrode
material. Each electrode disk was 0.002″ thick.

| | Average mass of | Volume of | Electrode |
|---|---|---|---|
| | two electrodes | two electrodes | Density |
| Carbon Type | (mg) | (cm³) | (g/cm³) |
| SPC 2A and SPC 2B | 20.4 | 0.022 | 0.94 |
| YP-50 | 13.5 | | 0.63 |
| SPC 1A and SPC 1B | 21.4 | | 0.99 |

II. Test Capacitors

After cooling, the vacuum container holding the electrodes (still under vacuum) was transferred into a drybox and all subsequent assembly work was performed in the drybox. Cells of the electrode materials were fabricated using an electrolyte of acetonitrile (ACN) with 1.0 M concentration of tetraethylammonium-tetrafluoroborate (TEATFB) salt. NKK separator TF 4035 (35 micrometers thick) was used. The thermoplastic heat seal material was selected for electrolyte compatibility and low moisture permeability.

Assembled cells were removed from the drybox for testing. Metal plates were clamped against each conductive faceplate and used as current collectors. A cross section of an assembled capacitor cell is shown in FIG. 1.

Prototype capacitor cells constructed to test the electrode materials had electrodes that were 0.002 inches thick and a diameter of 0.625 inches. The separator had a thickness of about 0.001 inches.

III. Measurements and Results

Test equipment that was used in the measurement and testing included: Frequency Response Analyzer (FRA), Solartron model 1255; Electrochemical Interface, Solartron model 1286; Digital Multimeter, Keithley Model 197; Power Supply, Hewlett-Packard Model E3610A; Balance, Mettler H10; Micrometer, Mitutoya; Leakage current apparatus; Arbin battery/capacitor tester model BT2000.

All measurements were performed at room temperature. The test capacitors were first conditioned by holding them at 2.0 V for 10 minutes. Cells were then discharged and the following measurements were made: leakage current after 30 minutes at 1.0 V, then after 30 minutes at 1.5 V, then after 30 minutes at 2.0 V, and finally electrochemical impedance spectroscopy at 2.0 V bias. Then charge/discharge measurements were performed using the Arbin to determine capacitance as a function of discharge current. A series of constant-power discharge measurements were performed to develop a Ragone plot. Then leakage current at 2.7 V (during a four-hour hold) and open circuit voltage decay (8 hour) were measured. Finally the cells were subjected to 1200 constant-current charge/discharge cycles using a current of 10 mA.

Table II lists test data for three capacitors, two capacitors with electrodes fabricated using SPC 2A and SPC 2B, along with one YP-50 capacitor.

TABLE II
Test results of prototype symmetric capacitors
constructed with the SPC 2A and 2B samples and
along with results for the YP-50 sample.

| | | | | | | F/g | F/cc |
|---|---|---|---|---|---|---|---|
| | ESR* | C** | 30 min leakage current (μA) | | | @ | @ |
| ID | (Ω) | (F) | 1.0 V | 1.5 V | 2.0 V | 2.7 V | 2.7 V |
| SPC 2A | 0.42 | 0.255 | 14.7 | 17.9 | 50.3 | 50 | 47 |
| SPC 2B | 0.34 | 0.238 | 10.6 | 15.7 | 39.3 | 47 | 44 |
| YP-50 | 0.46 | 0.336 | 5.1 | 14.4 | 68.8 | 99 | 62 |
| #1 | | | | | | | |

*ESR from electrochemical impedance spectroscopy
**constant current discharge from 2.7 V to 1.35 V using a current of 15 mA for all cells

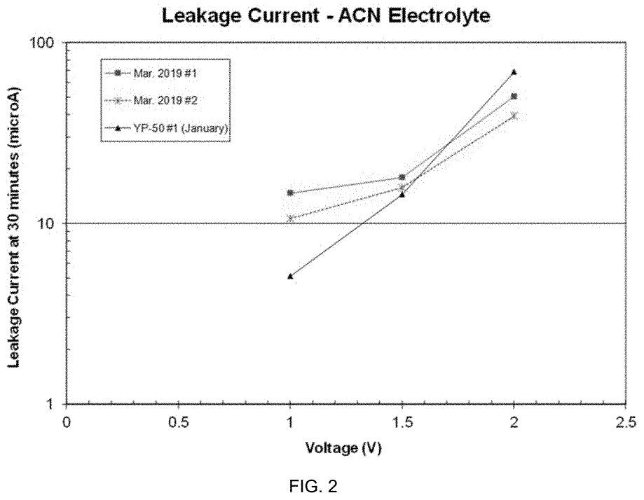

FIG. 2 shows 30-minute leakage current values at three different voltages for the symmetric test cells. In particular, FIG. 2 shows 30-minute leakage current values at three different voltages for the symmetric test cells. The leakage current of each device is close to a log-linear relationship with voltage, which is expected for properly operating electrochemical capacitors. Such behavior is seen when leakage current is dominated by normal charge transfer reactions and those associated with impurities. Linearity demonstrates that the cells are valid test vehicles.

The leakage current of each device is close to a log-linear relationship with voltage, which is expected for properly operating electrochemical capacitors. Such behavior is seen when leakage current is dominated by normal charge transfer reactions and those associated with impurities. Linearity demonstrates that the cells are valid test vehicles.

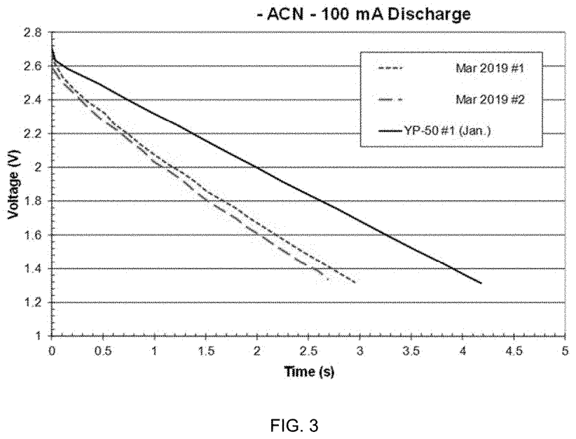

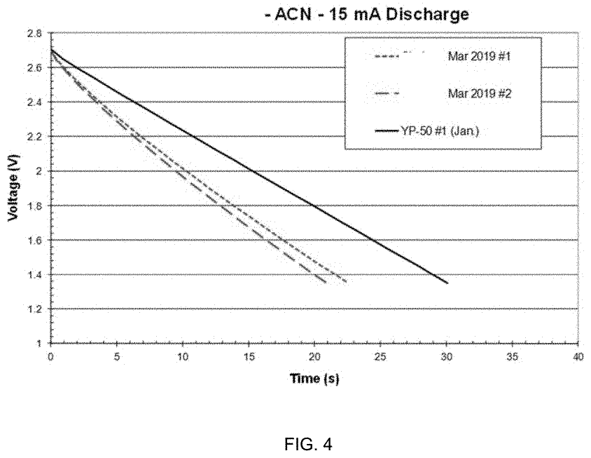

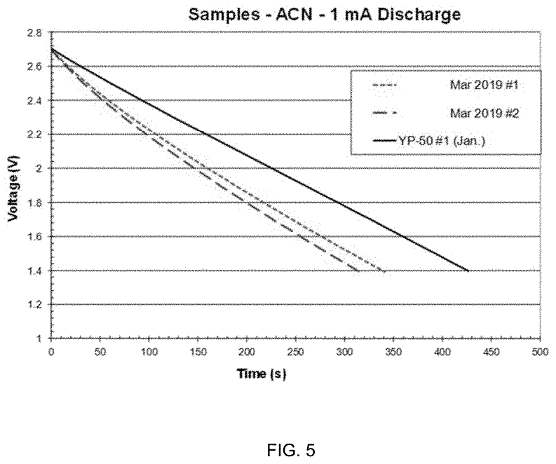

FIGS. 3-5 show constant-current discharge behavior for the symmetric capacitor cells made with the SPC 2A, 2B sample and the one made and reported in YP-50 electrodes. The discharge capacitances reported in the tables were calculated as C=I*t/ΔV using the endpoint time and voltage values, after the initial t=0 IR drop.

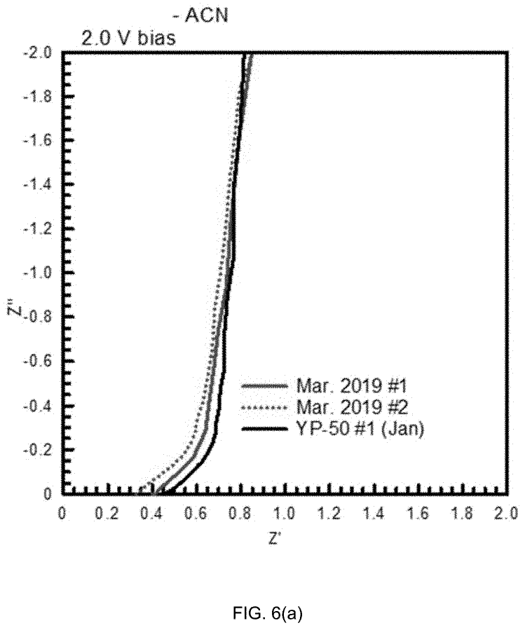

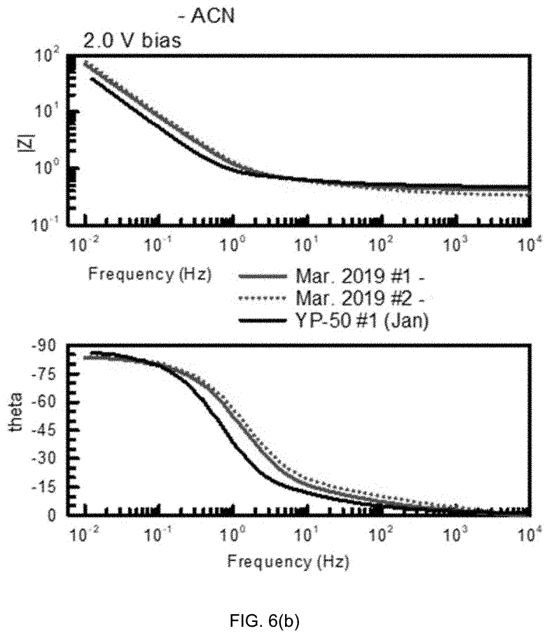

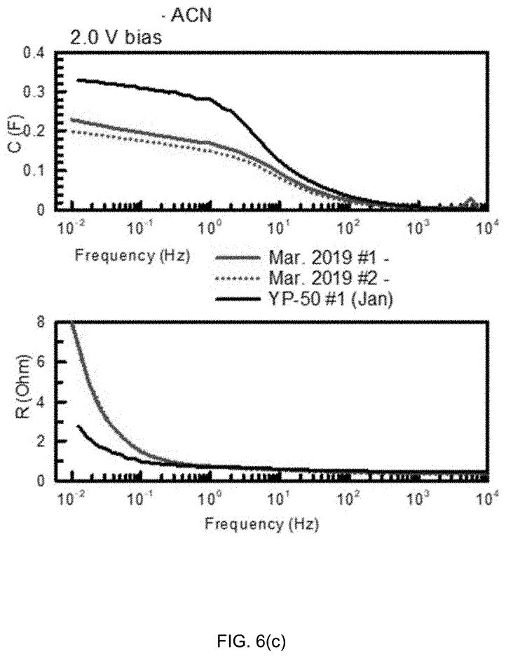

FIG. 6(a) shows impedance data in a complex-plane representation for the test capacitors at a bias voltage value of 2.0 V. The equivalent series resistance (ESR) is the value of the impedance at the intersection with the real axis. Shown is an intersection with the real axis at ˜0.4Ω for the cells. Then the lines rise at an angle of ˜45 degrees before becoming vertical. The 45° segment is similar for all the capacitors and is observed in storage devices when they have porous electrodes, which is due to distributed charge storage. It is ionic behavior and due to electrolyte resistance down the pores with charge stored along the pore-walls. In particular, FIG. 6(a) is a complex plane representation of impedance data from the capacitors with ACN based organic electrolyte. The ESR is the intersection with the real axis. All samples exhibited a similar degree of porous electrode behavior.

FIG. 6(b) shows the same impedance data in a Bode representation, which is the magnitude of the impedance |Z| and the phase angle, both values versus frequency. Capacitive behavior is evident by the −1 slope and the phase angles approaching −90 degrees at low frequencies. The capacitors with SPC 2A and SPC 2B carbon (March 2019 #1, March 2019 #2, respectively) become capacitive at higher frequency than the capacitors with electrodes of YP-50 carbon, i.e. the SPC 2A and SPC 2B carbon exhibited higher frequency response. In particular, FIG. 6(b) is a Bode representation of impedance data for the capacitors with ACN based organic electrolyte. Note the phase angle approaches −90 degrees at low frequencies.

FIG. 6(c) shows the same data in yet another representation—assuming a test capacitor can be represented by a series-RC circuit. The capacitance is calculated as −1/(2πfZ″), where f is the frequency in Hz, Z″ is the imaginary part of the impedance (reactance), and π=3.14. Capacitance increases from a minimum value at ˜10⁴ Hz in a monotonic fashion as the frequency is reduced. In particular, FIG. 6(c) is impedance data represented as a series-RC circuit. The capacitance is calculated using the imaginary part of the impedance. Note that capacitance is not saturated at the lower frequencies for the either type of test capacitor.

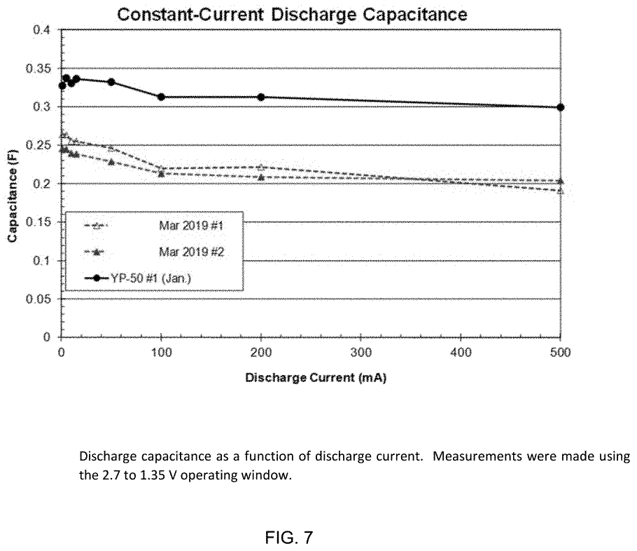

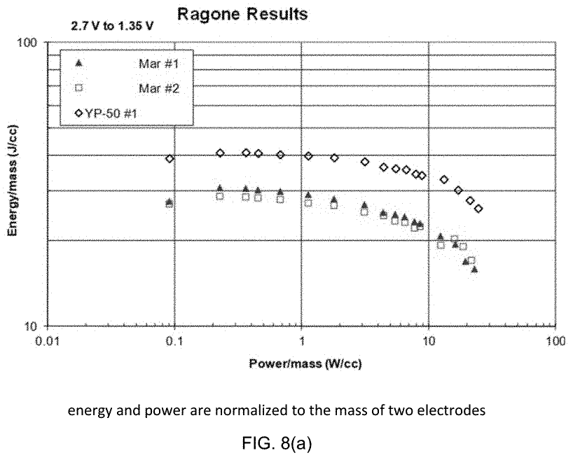

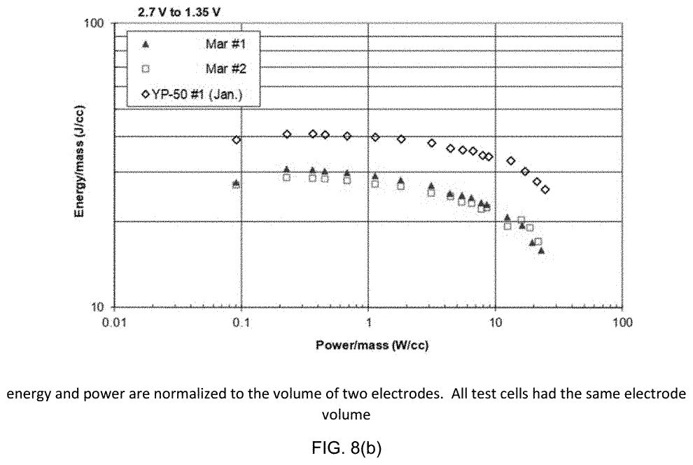

Table III and FIG. 7 show discharge capacitance values for the test capacitors at different discharge currents. The discharge times span the range from ˜5 minutes to about 1 s. Constant-power discharge measurements were used to develop the Ragone energy-power relationship for the cells. FIGS. 8(a) and (b) show Ragone plots for the test cells measured using constant power discharges from 2.7 V to 1.35 V with the Arbin tester.

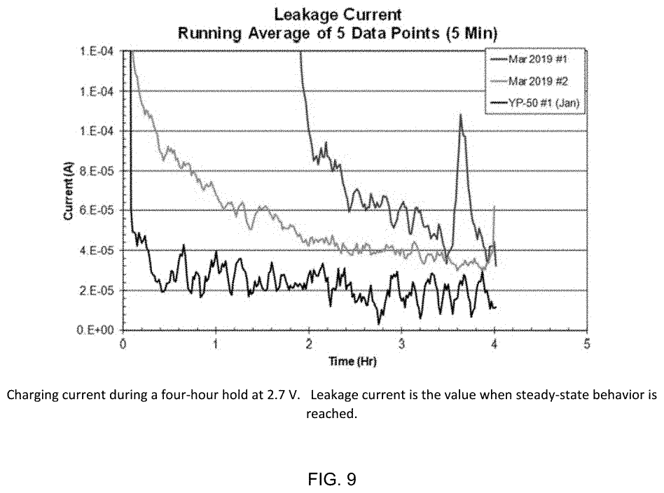

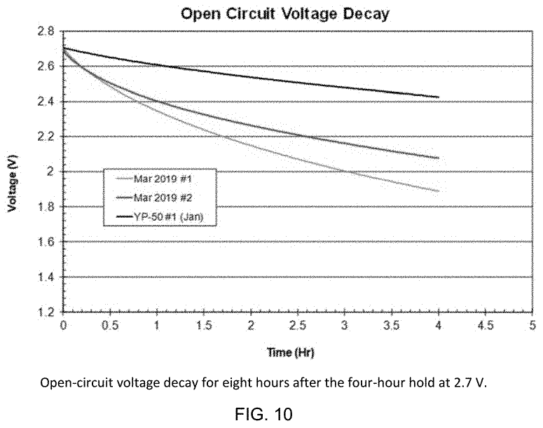

FIG. 9 shows leakage current during a four-hour hold at 2.7 V and FIG. 10 shows open-circuit voltage decay for 8 hours after the four-hour hold. In March these measurements were made before cycling but in January these measurements were made after cycling. These properties depend on the history of the capacitors; leakage current is lower and self-discharge is slower when the capacitors have been held at maximum voltage for longer times. Thus, the results for the YP-50 capacitor cannot be compared directly to the SPC 2A/2B; the lower leakage current and slower self-discharge for the YP-50 capacitor may be due to performing the measurements after extended cycling. The leakage current and self-discharge results for the SPC 2A/2B capacitors are reasonable and indicate no impurity problem that causes excessive leakage current or fast self-discharge.

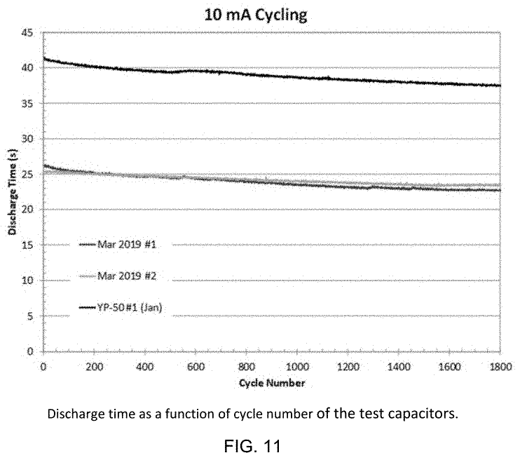

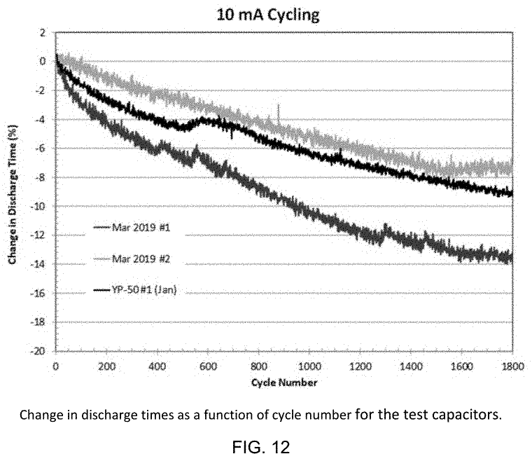

FIGS. 11 and 12 show discharge times and percent change in discharge time as a function of cycle number for 10 mA constant-current charge/discharge cycling. In January, this measurement was made before leakage current and self-discharge measurements but for the March 2019 test capacitors it was measured after. Thus, absolute cycle times cannot be directly compared for the two types of test cells. Cycle-time fade rates are comparable for the two types of cells indicating there is no serious impurity problem with the March 2019 carbon (SPC 2A, SPC 2B).

TABLE III
Discharge capacitance values calculated from constant-
current discharge measurements from 2.7 V to 1.35 V.

| | ID | | |
|---|---|---|---|
| Current | Capacitance (F) | | |
| (mA) | SPC 2A | SPC 2B | YP-50 #1 |
| 1 | 0.264 | 0.245 | 0.327 |
| 5 | 0.263 | 0.244 | 0.337 |
| 10 | 0.255 | 0.239 | 0.331 |
| 15 | 0.255 | 0.238 | 0.336 |
| 50 | 0.246 | 0.228 | 0.332 |
| 100 | 0.219 | 0.213 | 0.313 |
| 200 | 0.221 | 0.209 | 0.313 |
| 500 | 0.191 | 0.204 | 0.299 |

IV. Summary

Summary electrode results for the SPC samples and for a YP-50 control are shown in Table IV. The SPC 2A and 2B samples show much greater charge storage on both gravimetric and volumetric bases compared with the SPC 1A, 1B, 1C samples even though there was only a small reduction in electrode density. Note for the performance of commercial capacitors, it is the volumetric capacitance that is the more important metric.

TABLE IV
Capacitance and electrode density values.

| | | | Electrode |
|---|---|---|---|
| | F/g | F/cc | Density |
| ID | @ 2.7 V | @ 2.7 V | (g/cm³) |
| SPC 2A | 50 | 47 | 0.94 |
| SPC 2B | 47 | 44 | |
| SPC 1A | 22 | 22 | 0.99 |
| SPC 1B | 26 | 26 | |
| SPC 1C | 30 | 29 | |
| YP-50 #1 | 99 | 62 | 0.63 |

Electrochemical capacitors (aka ultracapacitors, supercapacitors) having electrodes fabricated with the SPC possess excellent volumetric capacitance values of ˜45 F/cc and good specific capacitance values of ˜50 F/g. Volumetric capacitance is the important parameter for commercial carbons. These capacitance values translate into high capacity and high energy for battery and hybrid ion device applications.

Electrodes made from the SPC had much higher density (˜0.94 g/cm³) than those made from YP-50 carbon (0.63 g/cm³). Since YP-50 is known to be the highest density supercapacitor carbon available commercially, SPC represents the state-of-the art. The high density is due to the unique textural properties of the carbon and is critical for achieving high energy density in electrochemical capacitors, batteries and hybrid ion devices. High density of a porous carbon is very important for volume limited energy storage applications.

Leakage-current and open-circuit voltage decay measurement (aka self-discharge measurements) indicate that SPC is superior to Kuraray YP-50, especially at high V where it matters the most. This is due to the unique structure and chemistry of SPC, including low inorganic impurity content and high degree of internal ordering (low defectiveness). Since YP-50 is known to be the lowest self-discharge supercapacitor carbon available commercially, SPC represents the state-of-the art. The leakage-current and open-circuit voltage gives a number of major advantages for carbons in energy storage applications. For ultracapacitors, batteries and hybrid ion devices this allows this allows for less parasitic side reactions with the electrolyte, for an extended voltage window, for higher power, for higher energy and higher extended cyclability.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A carbon material comprising:
a mean particle size between 1-40 microns;
a BET surface area between 750-3500 m²/g; and
a pore size distribution being at least one of microporosity, mesoporosity, and macroporosity,
wherein the carbon material is derived from a natural precursor or synthetic precursor.

2. The carbon material according to claim 1, wherein a maximum content of O is less than 7 wt. %.

3. The carbon material according to claim 2, wherein a maximum content of O is less than 4 wt. %.

4. The carbon material according to claim 3, wherein a maximum content of O is less than 2 wt. %.

5. The carbon material according to claim 1, wherein the natural precursor is selected from a group consisting of a fibrous plant material, wood, a forestry product, a petroleum product, coal, an agricultural product, and combinations thereof.

6. The carbon material according to claim 5, wherein the fibrous plant material is one of hemp or cannabis.

7. The carbon material according to claim 1, wherein the synthetic precursor is an industrial plastic.

8. The carbon material according to claim 1, wherein the mean particle size is between 2-20 microns.

9. The carbon material according to claim 1, wherein the BET surface area between 1000-3500 m²/g.

10. The carbon material according to claim 1, wherein the pore size distribution comprises:
50% of pore volume comprising a width of between 2-4 nm.

11. The carbon material according to claim 10, further comprising 50% of pore volume comprising a width of between 1-2 nm.

12. An energy storage device comprising:
an anode; and
a cathode,
wherein at least one of said anode and cathode includes a carbon material according to claim 1.

13. The energy storage device according to claim 12 comprising a volumetric capacitance of 45 F/cc.

14. The energy storage device according to claim 12, wherein the device is a symmetric electrochemical capacitor.

15. The energy storage device according to claim 14, further comprising an organic electrolyte.

16. The energy storage device according to claim 15, wherein the organic electrolyte comprises 1.0 M tetraethylammonium tetrafluoroborate (TEATFB) salt in acetonitrile solvent.

17. The energy storage device according to claim 12, wherein:
the anode is a zinc-based anode; and
the cathode is an oxide-based cathode,
the carbon material is combined with the zinc-based anode and the oxide-based cathode.

18. An electrode for an energy storage device comprising a carbon material according to claim 1.

19. The electrode according to claim 10 comprising a density of 0.94 g/cm³.

20. The electrode according to claim 17, wherein:
the electrode is a zinc-based anode; or
the electrode is an oxide-based cathode.
